(19) United States
(12) Patent Application Publication
(10) Pub. No.: US 2006/0141894 A1
(43) Pub. Date: Jun. 29, 2006

(54) Process for producing a radiation source, and radiation source

(76) Inventors: Thomas Hippke, Grossolbersdorf (DE); Jorg Hohlfeld, Chemnitz (DE); Markus Stange, Berlin (DE); Clemens Wesseling, Potsdam (DE)

Correspondence Address: OSRAM SYLVANIA INC, 100 ENDICOTT STREET, DANVERS, MA, 01923, US

(21) Appl. No.: 11/299,684

(22) Filed: Dec. 13, 2005

(30) Foreign Application Priority Data
Dec. 29, 2004 (DE) 10 2004 063 262.6
Jan. 14, 2005 (DE) 10 2005 001 949.8

(51) Int. Cl. H01J 9/00

(52) U.S. Cl. 445/26; 313/292

(57) ABSTRACT

The invention relates to a process for producing a radiation source and to a radiation source with at least one glass or ceramic element and at least one carrier element, the glass or ceramic element and the carrier element being joined to one another by metal foam within a joining region. Optionally, the carrier element may itself be a part which consists of metal foam.

### TECHNICAL FIELD

The invention relates to a process for producing a radiation source with at least one glass or ceramic element and at least one carrier element, and to a radiation source with at least one glass or ceramic element and at least one carrier element.

In particular, the present invention relates to the production of a lamp, in particular a discharge lamp, as is preferably used in lighting technology, in domestic engineering and in the automotive industry, and to radiation sources of this type. Furthermore, the present invention also relates to similar elements and assemblies which have a radiation source, for example a Braun tube, as is used in television screens and computer monitors.

### BACKGROUND ART

Known radiation sources, in particular incandescent lamps and discharge lamps, often comprise a glass or ceramic hollow body which is connected to one or more bases. Furthermore, conventional incandescent lamps and discharge lamps have electrical feedlines which are connected to an incandescent device or a discharge device in the interior of the incandescent lamp or discharge lamp.

The base(s) of an incandescent lamp or a discharge lamp are often designed as metallic or ceramic sleeves, the electrical feedlines being connected to the metallic sleeve or a terminal element insulated from the metallic sleeve or to electrically conductive terminal elements in a ceramic sleeve. The electrical feedlines often consist of molybdenum foils or wires which are partially or completely embedded in quartz and are contact-connected to the metallic base or the electrically conductive terminal parts (for example by welding, soldering, clamping, pinching, etc.).

On account of the high temperatures which incandescent and discharge lamps reach in operation, it is not possible for organic adhesives to be used to join the glass or ceramic element to the base or to further components of the lamp, such as for example a reflector or an end cap, since these adhesives are destroyed by the high operating temperatures. The high-temperature-resistant adhesives which are commercially available and are predominantly also used in lamp engineering are generally ceramic cements or ceramic adhesives which are sufficiently thermally stable.

The join is usually produced in a number of steps: positioning and fixing the light-generating lamp region with respect to the terminal parts, filling the gap which is formed with ceramic cement or adhesive, if necessary precision alignment of the components with respect to one another, and finally the drying and hardening of the ceramic cement, if appropriate assisted and accelerated by a heat treatment.

These known processes for producing a radiation source, and the correspondingly produced radiation source, however, are subject to a number of serious drawbacks on account of the ceramic cement or adhesive used. Firstly, the drying and heat treatment steps described above are very labor-intensive and time-consuming, and therefore expensive. Ceramic cements can only be worked for a limited period of time, known as the pot life, before the incipient curing process prevents further processing. On account of the limited pot life of the ceramic cements and a general tendency to segregate, process automation for production of the radiation source is possible but involves high levels of maintenance and often also entails high scrap rates.

Secondly, there is a risk of a join which is produced by a ceramic cement or adhesive being released as a result of unfavorable conditions during processing or assembly, as a result of unfavorable climate conditions or in the event of fluctuating thermal stresses. In this case, the cement collapses, becomes detached from the adjoining materials and/or crumbles, which leads to failure of the join and of the radiation source. To prevent the adhesive bond from failing, currently relatively expensive ceramic cements and adhesives are used to produce radiation sources and/or longer drying and curing times or heat treatments are accepted. Both approaches entail increased production costs for the radiation source.

### DISCLOSURE OF THE INVENTION

Therefore, it is an object of the present invention to improve a process for producing a radiation source of the type described in the introduction in such a manner that the process allows the production of a radiation source in a simple and inexpensive way.

A further object of the present invention is to improve a radiation source of the type described in the introduction in such a manner that the service life of the radiation source changes, by improving the join between a glass or ceramic element of the radiation source and adjacent components.

With regard to the production process, the abovementioned object is achieved, according to a first aspect of the invention, by a process for producing a radiation source with at least one glass or ceramic element and at least one carrier element, wherein the glass or ceramic element and the carrier element are joined to one another by metal foam within a joining region.

With regard to the production process, the abovementioned object is achieved, according to a second aspect of the invention, by a process for producing a radiation source with at least one glass or ceramic element and at least one carrier element, wherein the carrier element is produced as a foamed carrier element made from metal foam.

Both processes are advantageously suitable for simplifying the production of a radiation source by the use of metal foam. The use of metal foam reduces the process chain by changing the complex drying and heat treatment phase which is required to cure a ceramic cement to a short heat treatment to trigger the foaming of the metal foam. Furthermore, the process according to the invention makes it possible to dispense with a conventional carrier element and instead to produce the latter as a foamed carrier element made from metal foam. This process further shortens the process chain involved in the production of a radiation source.

According to a preferred exemplary embodiment of the first process, the metal foam is arranged in an intermediate space between the glass or ceramic element and the carrier element. The heat treatment process forms a join between the glass or ceramic element and the carrier element.

According to a further preferred exemplary embodiment of the first process, a foamable precursor material is introduced into an intermediate space between the glass or ceramic element and the carrier element. The foamable precursor material can be prefabricated in any desired format, in particular as a semifinished product in wire form or as a flat semifinished product, and placed loosely between or bearing against the carrier element and/or glass or ceramic element. The foamable precursor material is foamed to form the metal foam by activation of this foamable precursor material in the intermediate space, for example by an induction process. During the subsequent cooling, the join between the glass or ceramic element and the carrier element is formed. It is in this way possible to further shorten the process chain, since there is no need to provide a metal foam beforehand, but rather the metal foam is formed at the location at which it subsequently also performs its joining task.

It is advantageous if the carrier element is made from a material with a melting point which is equal to or higher than the foaming point of the metal foam. This prevents the carrier element from being deformed or melting on account of the high temperatures during the introduction of the metal foam or during the activation of the foamable precursor material. After the glass or ceramic element and the carrier element have been positioned relative to one another, it remains possible to alter the position of the glass or ceramic element with respect to the carrier element up until solidification of the metal foam commences, in order to compensate for alignment inaccuracies caused by the introduction of the metal foam or by the activation of the foamable precursor material.

According to a preferred exemplary embodiment of the second process, a joining region of the glass or ceramic element which is to be surrounded with foam is positioned in a foaming mold. The foaming mold represents a negative image of the carrier element to be foamed. If metal foam is introduced into the foaming mold or a foamable precursor material is activated in the foaming mold, the metal foam is joined to the glass or ceramic element and at the same time reproduces the negative of the foaming mold as a positive image.

According to a further preferred exemplary embodiment of the second process, the configuration of the foaming mold results in the reproduction of at least one receiving element, preferably a receiving undercut, a receiving groove or a receiving thread, in the foamed carrier element. This further shortens the process chain involved in the production of a radiation source, since not only is it possible to dispense with a prefabricated carrier element, but also the foamed carrier element does not have to be reworked by deformation or machining in order to allow subsequent, tight-fitting installation of the radiation source.

In a further preferred exemplary embodiment of the second process, the temperature of the foaming mold is controlled in order to make cells of the metal foam collapse in those regions of the foamed carrier element which adjoin the foaming mold. This results in the formation of receiving elements, i.e. the accurately shaped reproduction of the receiving elements, from the negative of the foaming mold.

For both processes mentioned, it is advantageous if the metal foam is produced by a melt-metallurgy process or by activating the foamable precursor material, preferably by induction, conduction or infrared radiation. The induction process is particularly suitable, since the heating takes place quickly and the heat treatment process can be accurately controlled.

According to a particularly preferred exemplary embodiment of the processes mentioned above, at least one radiation unit and/or at least one electrical feedline is arranged in the glass or ceramic element, and the radiation unit and/or the electrical feedline, within the joining region, is electrically conductively connected by metal foam to the carrier element or to the foamed carrier element. This further shortens the production process, since it is no longer necessary for electrical feedlines to be connected to a carrier element, for example a base, by an additional joining process, for example by welding.

Furthermore, it is advantageous if the force-fitting and/or form-fitting joining properties of the metal foam are boosted by at least one joining element at the glass or ceramic element and/or the carrier element, preferably by an undercut and/or a groove. This makes it possible to dispense with further process steps for securing the join between the glass or ceramic element and the carrier element or the foamed carrier element, for example by a deformation process.

Further preferred exemplary embodiments of the processes for producing a radiation source are explained in further dependent claims.

With regard to the radiation source, the object described in the introduction is achieved, according to a first aspect of the invention, by a radiation source with at least one glass or ceramic element and at least one carrier element, wherein the glass or ceramic element and the carrier element are joined to one another by metal foam within a joining region.

With regard to the radiation source, the object described in the introduction is achieved, according to a second aspect of the invention, by a radiation source with at least one glass or ceramic element and at least one carrier element, wherein the carrier element is a foamed carrier element which consists of metal foam.

As has already been described above, the use of metal foam simplifies the production of the radiation source, which means that it can be produced at lower cost. Secondly, the use of metal foam lengthens the service life of the radiation source, since metal foam is not subject to the destruction mechanisms which are known for adhesives or ceramic cements. Moreover, metal foam has a very good thermal conductivity, which is of benefit to the cooling of the supply conductor in particular in the case of lamps with high operating temperatures, for example high-pressure discharge lamps. If the radiation source is switched on and off frequently, metal foam, on account of its structure, allows better compensation for the stresses which this generates in the radiation source and are caused by the different thermal expansion and subsequent contraction of the different components of the radiation source.

In a preferred exemplary embodiment of the first apparatus claim, within the joining region there is an intermediate space between the glass or ceramic element and the carrier element, into which space metal foam has been introduced in order to compensate for stresses caused by the different thermal expansion properties of the different components of the radiation source.

Furthermore, even when producing the radiation source, it is advantageous if the carrier element consists of a material with a melting point which is equal to or higher than the foaming point of the metal foam.

It has therefore proven advantageous for the carrier element to consist of a metallic, ceramic or vitreous material or of a combination of said materials.

According to a preferred exemplary embodiment of the second apparatus, the foamed carrier element is joined to the glass or ceramic element in a joining region. This allows a defined transfer of the heat produced in operation between the glass or ceramic element and the foamed carrier element to be ensured.

According to a further preferred exemplary embodiment of the second apparatus, the outer regions of the foamed carrier element have a higher density and lower porosity than regions of the foamed carrier element which lie closer to the glass or ceramic element which has been surrounded by foam. The lower porosity is associated with an increased dimensional stability and surface quality of the outer region of the foamed carrier element, with the result that, for example, defined receiving elements can be produced with the required dimensional stability and accuracy within this region.

The radiation source according to the abovementioned apparatus claims is preferably a lamp, for example a discharge lamp, in which high operating temperatures can occur.

The glass or ceramic element and/or the carrier element advantageously has at least one joining element, which is preferably designed as an undercut and/or groove. A joining element of this type boosts the force-fitting and/or form-fitting joining properties of the metal foam, preventing failure of the join and lengthening the service life of the radiation source.

The carrier element or the foamed carrier element is preferably a base, a reflector or an end cap. Since these elements all have surfaces which are suitable for cooling the radiation source, joining these carrier elements to the glass or ceramic element, which warms up in operation, by means of the metal foam of good thermal conductivity allows rapid dissipation of the operating heat.

According to a further preferred exemplary embodiment, the carrier element or the foamed carrier element has at least one receiving element, preferably a receiving undercut, a receiving groove or a receiving screw thread, in an outer region. With the aid of this receiving element, the radiation source can, for example, be introduced in a force-fitting manner into a receiving apparatus, e.g. a lamp mount, provided for this purpose.

According to a particularly preferred exemplary embodiment, at least one radiation unit and/or at least one electrical feedline is arranged in the glass or ceramic element. Within the joining region, the radiation unit and/or the electrical feedline is electrically conductively connected by metal foam to the carrier element or to the foamed carrier element. In this case, the metal foam performs not just a thermally conducting function but also an electrically conducting function, thereby reducing the number of manufacturing steps or the number of components.

According to a further particularly preferred exemplary embodiment of the radiation source, the radiation unit and/or the electrical feedline, within the joining region, has an insulation which prevents contact with the metal foam and/or other electrically conductive elements, for example a further feedline. This makes it possible, for example, for two separate electrical feedlines to be arranged within one carrier element or one foamed carrier element without producing a short circuit when the radiation source is operating.

Further preferred exemplary embodiments of the radiation sources are explained in further dependent claims.

### BRIEF DESCRIPTION OF THE DRAWINGS

The present invention is explained in more detail below on the basis of preferred exemplary embodiments in conjunction with the associated figures, in which:

FIG. 1 shows a sectional illustration of a discharge lamp;

FIG. 2 shows a sectional illustration of the discharge lamp with a base, a reflector and an end cap;

FIG. 3 shows a sectional illustration of a glass or ceramic element and a carrier element;

FIG. 4 shows a sectional illustration of the glass or ceramic element and the carrier element which are joined by metal foam;

FIG. 5 shows a sectional illustration of the glass or ceramic element and the carrier element with a foamable precursor material;

FIG. 6 shows a sectional illustration of the glass or ceramic element and the carrier element which have been joined by metal foam after activation of the foamable precursor material;

FIG. 7 shows a sectional illustration of the glass or ceramic element encased with metal foam (carrier element) in a foaming mold; and

FIG. 8 shows a sectional illustration of the glass or ceramic element with a foamed carrier element.

### BEST MODE FOR CARRYING OUT THE INVENTION

The structure of a radiation source according to the invention is shown in FIG. 1 based on the example of a sectional illustration of a discharge lamp. The discharge lamp comprises a glass or ceramic element 1 with a radiation unit 8 arranged in its interior. In the exemplary embodiment shown, the radiation unit 8 is made up of two electrodes which are surrounded by a gas. However, it is also conceivable for the radiation unit 8 to be designed, for example, as an incandescent filament or as electrodes which are in a vacuum.

The radiation unit 8 is connected to electrical feedlines 9. The radiation source 8 shown is a preferably tubular discharge lamp with two opposite ends, so that the electrical feedlines 9 also lead in two opposite directions. At each of its ends, the discharge lamp shown has a carrier element 2a, which is designed as a metallic or ceramic base.

Metal foam 4 which joins the glass or ceramic element 1 to the carrier element 2a is located within a joining region 3. Furthermore, depending on the intended use and structure of the radiation source, it is conceivable for the metal foam 4 to connect the electrical feedline 9 within the joining region 3 to the carrier element 2a, for example a metallic base. In addition, the metal foam 4 can also be used to connect the electrical feedline 9 to a further electrically conductive element within a nonconductive carrier element 2a. Furthermore, it is possible for this connection or the electrical feedline 9 to be insulated by a vitreous or ceramic material at a further electrical feedline or from the metal foam 4 or the carrier element 2a, in order to avoid short circuits when the discharge lamp is operating. This may be necessary, for example, if the radiation source has only a single base, through which at least two electrical feedlines 9, required to supply current to the radiation unit 8 (not shown), run.

In the exemplary embodiments described above, the metal foam 4 in addition to performing the function of a thermally conductive joining material, also performs the function of an electrically conductive connection.

The discharge lamp with a plurality of carrier elements 2a, namely a base 12, a reflector 13 and an end cap 14, is shown in sectional illustration in an exemplary embodiment shown in FIG. 2. On one side, the glass or ceramic element 1 is joined to the base 12 by the metal foam 4. The metal foam 4 is also suitable for joining the reflector 13 and/or the end cap to the base 12, so as to form an integrated optical system in which all the elements are joined to one another by metal foam 4. Therefore, in certain regions it may be necessary for the electrical feedlines 9 or the carrier elements 2a which are in contact with the metal foam 4 to be electrically insulated.

When the radiation source is operating, the surface of the entire optical system is used to dissipate the operating heat formed in the glass or ceramic element 1. This is achieved by the thermal conductivity of the metal foam 4 which is used as joining material between the individual components of the optical system. Furthermore, the structure and properties of the metal foam 4 make it possible to compensate for the different expansion properties of different materials of the optical system shown.

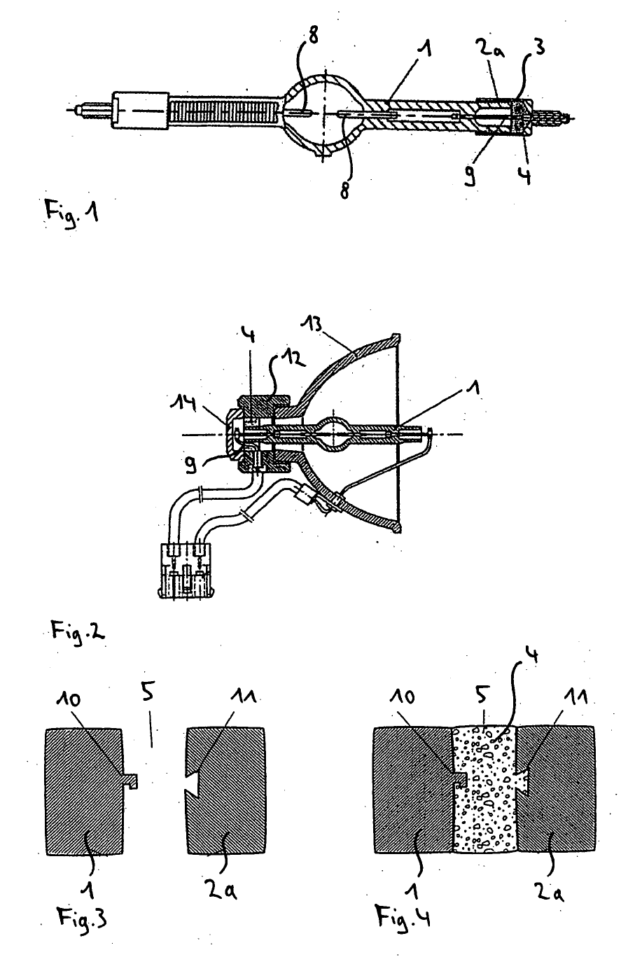

An exemplary embodiment shown in FIG. 3 presents a sectional illustration of the glass or ceramic element 1 and the carrier element 2a. Within the joining region 3, the two components are separated from one another by an intermediate space 5. Furthermore, in the exemplary embodiment shown, the glass or ceramic element 1 is provided with an undercut 10, while the carrier element 2a has a groove 11. These joining elements shown may also be of other designs in order to boost the force-fitting and/or form-fitting joining properties of the metal foam 4 when the latter is introduced into the intermediate space 5.

It is expressly noted that the joining elements shown do not necessarily have to be present at the glass or ceramic element 1 and/or at the carrier element 2a, since a durable join is also possible exclusively by means of the cohesive, force-fitting and/or form-fitting joining properties of the metal foam.

The carrier element 2a may consist of a metallic, ceramic or vitreous material or of a combination of said materials. When selecting the carrier element 2a and the glass or ceramic element 1, it should be ensured that they consist of materials with a melting point which is equal to or higher than the foaming point of the metal foam 4, since otherwise said elements are deformed or destroyed during the introduction of the metal foam 4.

The exemplary embodiment shown in FIG. 4 differs from the exemplary embodiment shown in FIG. 3 by virtue of the fact that the glass or ceramic element 1 and the carrier element 2a are joined by the metal foam 4 which has been introduced into the intermediate space 5 within the joining region 3. The metal foam 4 consists, for example, of tin, zinc, aluminum, copper, iron or a corresponding foamable alloy and has a porous structure.

The glass or ceramic element 1 and the carrier element 2a are positioned relative to one another before the metal foam 4 is introduced. However, it is also possible for said elements to be positioned with respect to one another after the metal foam 4 has been introduced, or for their position to be changed after the metal foam 4 has been introduced, up until solidification of the metal foam 4 commences.

In an exemplary embodiment shown in FIG. 5, the glass or ceramic element 1 has a groove 11, while the carrier element 2a has an undercut 10. A foamable precursor material 6 has been introduced in the intermediate space 5 within the joining region 3. The foamable precursor material 6 consists, for example, of an aluminum alloy with a foaming agent, for example titanium hydride.

The exemplary embodiment shown in FIG. 6 differs from the exemplary embodiment shown in FIG. 5 by virtue of the fact that the precursor material 6 introduced has been activated and foamed to form the metal foam 4. The metal foam 4, as in the exemplary embodiment shown in FIG. 4, forms the intermediate space 5 within the joining region 3 between the glass or ceramic element 1 and the carrier element 2a.

When choosing the carrier element 2a, it should be ensured that it consists of a material with a melting point which is equal to or higher than the foaming point of the foamable precursor material 6.

The glass or ceramic element 1 and the carrier element 2a are positioned relative to one another prior to the activation of the foamable precursor material 6. However, it is also possible for the position of the glass or ceramic element 1 to be altered with respect to the carrier element 2a, up until solidification of the metal foam 4 commences.

In general, the metal foam 4 is produced by a melt-metallurgy process or by activating the foamable precursor material 6. The foamable precursor material 6 is preferably produced by a powder-metallurgy process as is also used, for example, for sintering. The activation of the foamable precursor material 6 takes place either in a separate device or within the joining region 3 of the glass or ceramic element 1 or of the carrier element 2a or in the intermediate space 5 between said elements. It is preferable for the foamable precursor material 6 to be activated by induction, conduction or infrared radiation.

In an exemplary embodiment which is not shown, the carrier element 2a has at least one receiving element in an outer region. This receiving element is designed, for example, as an undercut, groove or screw thread.

FIG. 7 shows a sectional illustration of the glass or ceramic element 1 in a foaming mold 7. The glass or ceramic element 1 is in this case designed as described above.

The foaming mold 7, in which the glass or ceramic element 1, or the joining region 3 of the glass or ceramic element 1 to be surrounded by foam, is positioned, represents a negative image of the carrier element to be foamed. This firstly includes the reproduction of receiving elements, for example undercuts, grooves or screw threads in the foaming mold 7, but secondly also the provision of certain regions in the foaming mold 7 for further components of the radiation source, for example electrical feedlines 9 or insulations.

A foamed carrier element 2b fills the region between the glass or ceramic element 1 and the foaming mold 7. As has already been described above in connection with the carrier element 2a, the foamed carrier element 2b may also include regions which are electrically connected to or insulated from the electrical feedline 9 and/or the radiation unit 8.

To produce the foamed carrier element 2b as a foam surrounding the joining region 3 of the glass or ceramic element 1, either metal foam 4 is introduced into the foaming mold 7, or foamable precursor material 6 is activated, for example by induction, within the foaming mold 7. As the foamed carrier element 2b solidifies, the foamed carrier element 2b is permanently joined to the glass or ceramic element 1.

To make it easier to remove the radiation source produced in this way from the foaming mold 7, it is advantageous if a release agent has previously been introduced into those regions of the foaming mold 7 which are in contact with the foamed carrier element 2b. Alternatively, the foaming mold 7 may consist of a material which includes the release function, or may consist of a composite system (composite material or covering layer which repels foam material) which, in addition to the shaping function, also incorporates the release function. Particularly for undercut geometries, a split mold with, for example, mold halves which can move at an angle with respect to a main axis of the foam body can be used. After the metal foam 4 has cooled or hardened, the radiation source is demolded from the foaming mold 7.

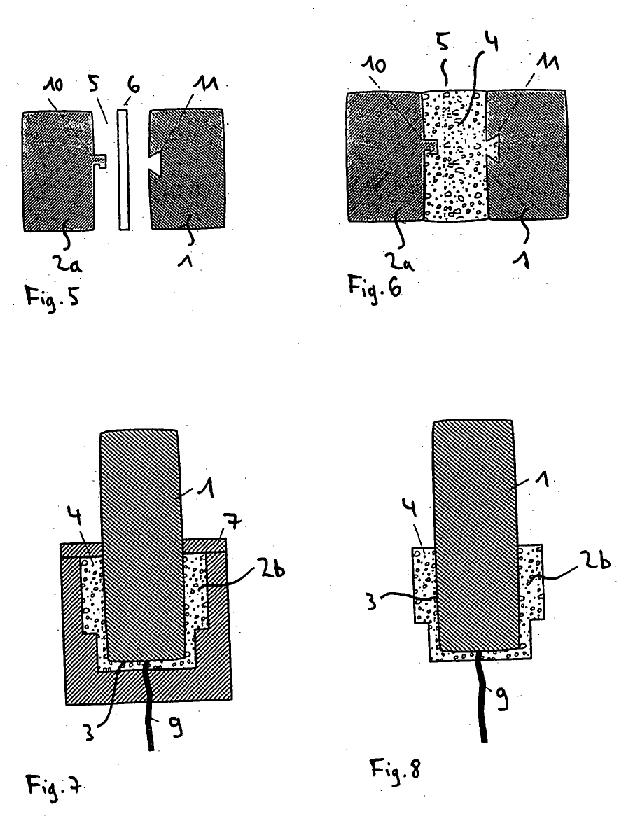

FIG. 8 shows a sectional illustration of the glass or ceramic element 1 with a foamed carrier element 2b which has been demolded from the foaming mold 7. The electrical feedline 9, which is in contact with the radiation unit 8 within the glass or ceramic element 1, is in the present case not electrically insulated from the foamed carrier element 2b within the region of the latter. It is equally possible, for example when using a plurality of feedlines, that electrical insulation of this nature may be necessary, or alternatively desirable for other reasons, and therefore realized.

In an exemplary embodiment which is not shown, the outer regions of the foamed carrier element 2b have a higher density and lower porosity than regions of the foamed carrier element 2b which lie closer to the glass or ceramic element 1 which has been surrounded by foam. This makes it possible for outer receiving elements, such as for example a receiving screw thread, to be reproduced more accurately and with a higher surface quality.

The compacting of the outer regions of the foamed carrier element 2b which is required for this purpose can be achieved on the one hand by suitably controlling the temperature of the foaming mold 7, with the result that cells of the metal foam 4 collapse in the regions adjoining the foaming mold 7, or on the other hand the compacting can also be achieved by a mechanical deformation and/or heat treatment carried out after demolding of the radiation source. It is also possible to graduate the metal foam density by the precursor material which is to be foamed being introduced, for example, in multiple layers and/or used with different foaming agent contents. Furthermore, it is also possible to graduate the metal foam density, for example, by combining unfoamable aluminum with foamable precursor material (e.g. Al foam).

The exemplary embodiments described above describe a process for producing a radiation source, as well as a radiation source, with at least one glass or ceramic element and at least one carrier element, the glass or ceramic element and the carrier element being joined to one another by metal foam within a joining region. Furthermore, the exemplary embodiments described above describe a process for producing a radiation source, as well as a radiation source, with at least one glass or ceramic element and at least one carrier element, the carrier element being a foamed carrier element which consists of metal foam.

1. A process for producing a radiation source with at least one glass or ceramic element and at least one carrier element, in that the glass or ceramic element and the carrier element are joined to one another by metal foam within a joining region.

2. A process for producing a radiation source with at least one glass or ceramic element and at least one carrier element, in that the carrier element is produced as a foamed carrier element made from metal foam.

3. The process as claimed in claim 1, in that the metal foam, which during the heat treatment forms the join between the glass or ceramic element and the carrier element, is introduced into an intermediate space between the glass or ceramic element (1) and the carrier element.

4. The process as claimed in claim 1, in that a foamable precursor material is introduced into an intermediate space between the glass or ceramic element and the carrier element, which foamable precursor material is foamed by activation in the intermediate space to form metal foam and as it cools forms the join between the glass or ceramic element and the carrier element.

5. The process as claimed in claim 1 in that before the metal foam is introduced into the intermediate space or before the foamable precursor material which has been introduced into the intermediate space is activated, the glass or ceramic element and the carrier element are positioned relative to one another.

6. The process as claimed in claim 1, in that the glass or ceramic element is placed into a foaming mold in which molten metal foam is present.

7. The process as claimed in claim 1, in that the position of the glass or ceramic element can be altered with respect to the carrier element even after the metal foam has been introduced into the intermediate space or after the foamable precursor material introduced into the intermediate space has been activated or after the glass or ceramic element has been placed into the foaming mold, up until solidification of the metal foam commences.

8. The process as claimed in claim 1, in that the carrier element is made from a material with a melting point which is equal to or higher than the foaming point of the metal foam.

9. The process as claimed in claim 2, in that a joining region of the glass or ceramic element which is to be surrounded with foam is positioned in a foaming mold which has a mating molded element for the carrier element to be foamed.

10. The process as claimed in claim 2, in that a release agent is introduced into the foaming mold or the foaming mold consists of a material which includes a release function, or the foaming mold itself embodies the release function.

11. The process as claimed in claim 2, in that the metal foam is introduced into the foaming mold.

12. The process as claimed in claim 2, in that a foamable precursor material is introduced into the foaming mold.

13. The process as claimed in claim 2, in that the configuration of the foaming mold results in the reproduction of at least one receiving element, preferably a receiving undercut, a receiving groove or a receiving screw thread, in the foamed carrier element.

14. The process as claimed in claim 2, in that those regions of the foamed carrier element which adjoin the foaming mold have a higher density and lower porosity than those regions of the foamed carrier element which lie closer to the glass or ceramic element which has been surrounded by foam.

15. The process as claimed in claim 14, in that the temperature of the foaming mold is controlled in order to compact the metal foam in those regions of the foamed carrier element which adjoin the foaming mold.

16. The process as claimed in claim 2, in that after the metal foam has cooled or hardened, the carrier element which has been foamed around the glass or ceramic element is demolded from the foaming mold.

17. The process as claimed in claim 1, in that the metal foam is used in the region of high operating temperatures and/or for temperature-related compensation for expansion properties of the glass or ceramic element and/or the carrier element joined to the metal foam and/or an operating environment of the radiation source.

18. The process as claimed in claim 1, in that the metal foam is produced by a melt-metallurgy process or by activating the foamable precursor material, preferably by induction, conduction or infrared radiation.

19. The process as claimed in claim 18, in that the foamable precursor material in the intermediate space between the glass or ceramic element and the carrier element or in the foaming mold is activated by induction.

20. The process as claimed in claim 18, in that the foamable precursor material is produced by a powder-metallurgy process.

21. The process as claimed in claim 1, characterized in that the metal foam or the foamable precursor material is produced, for example, from tin, zinc, aluminum, copper, iron or alloys thereof.

22. The process as claimed in claim 1, in that at least one radiation unit and/or at least one electrical feedline is arranged in the glass or ceramic element, and in that the radiation unit and/or the electrical feedline, within the joining region, is electrically conductively connected by metal foam to the carrier element or to the foamed carrier element.

23. The process as claimed in claim 1, in that a nonreleasable join between the glass or ceramic element and the carrier element or the foamed carrier element is produced by cohesive, force-fitting and/or form-fitting joining properties of the metal foam.

24. The process as claimed in claim 23, in that the force-fitting and/or form-fitting joining properties of the metal foam are boosted by at least one joining element at the glass or ceramic element and/or the carrier element, preferably by an undercut and/or groove.

25. A radiation source with at least one glass or ceramic element and at least one carrier element, in that the glass or ceramic element and the carrier element are joined to one another by metal foam within a joining region.

26. A radiation source with at least one glass or ceramic element and at least one carrier element, in that the carrier element is a foamed carrier element which consists of metal foam.

27. The radiation source as claimed in claim 25, in that within the joining region there is an intermediate space between the glass or ceramic element and the carrier element, into which space metal foam which joins the glass or ceramic element to the carrier element has been introduced.

28. The radiation source as claimed in claim 25, in that the carrier element consists of a material with a melting point which is equal to or higher than the foaming point of the metal foam.

29. The radiation source as claimed in claim 25, in that the carrier element consists of a metallic, ceramic or vitreous material or of a combination of said materials.

30. The radiation source as claimed in claim 26, in that the foamed carrier element is joined to the glass or ceramic element in a joining region.

31. The radiation source as claimed in claim 26, in that outer regions of the foamed carrier element have a higher density and lower porosity than regions of the foamed carrier element which lie closer to the glass or ceramic element which has been surrounded by foam.

32. The radiation source as claimed in claim 25, in that the metal foam allows a join which is resistant to high temperatures and the metal foam compensates for the changes in size at least of the glass or ceramic element resulting from high operating temperatures.

33. The radiation source as claimed in claim 25, in that the radiation source is a lamp, preferably a discharge lamp or incandescent lamp.

34. The radiation source as claimed in claim 25, in that the glass or ceramic element and/or the carrier element has at least one element which increases the surface area and is preferably designed as an undercut and/or a groove.

35. The radiation source as claimed in claim 25, in that the carrier element or the foamed carrier element is a base, a reflector or an end cap.

36. The radiation source as claimed in claim 25, in that the carrier element or the foamed carrier element has at least one receiving element, preferably a receiving undercut, a receiving groove or a receiving screw thread, in an outer region.

37. The radiation source as claimed in claim 25, in that the metal foam consists, for example, of tin, zinc, aluminum, copper, iron or corresponding alloys and has a porous structure.

38. The radiation source as claimed in claim 25, in that at least one radiation unit and/or at least one electrical feedline is arranged in the glass or ceramic element, and in that the radiation unit and/or the electrical feedline, within the joining region, is electrically conductively connected by metal foam to the carrier element or to the foamed carrier element.

39. The radiation source as claimed in claim 25, in that the radiation unit and/or electrical feedline, within the joining region, has an insulation which prevents contact with the metal foam and/or other electrically conductive elements.
